(19) United States
(12) Patent Application Publication
(10) Pub. No.: US 2024/0160153 A1
(43) Pub. Date: May 16, 2024

(54) Timepiece

(71) Applicant: SEIKO EPSON CORPORATION, Tokyo (JP)

(72) Inventor: Hideo KATO, Shiojiri (JP)

(21) Appl. No.: 18/505,669

(22) Filed: Nov. 9, 2023

(30) Foreign Application Priority Data
Nov. 10, 2022 (JP) 2022-180450

(51) Int. Cl. G04B 19/04; G04B 19/06; G04B 45/00; G04B 45/02

(52) U.S. Cl. CPC G04B 19/044; G04B 19/06; G04B 45/0084; G04B 45/02

(57) ABSTRACT

A timepiece includes a movement and a dial. The movement includes a first hand shaft to which a first hand is attached, a second hand shaft to which a second hand is attached, and an escapement speed control mechanism including a balance and a balance bush configured to support the balance pivotally. The dial includes a lower plate and an upper plate. The lower plate includes a lower plate ring portion and a frame portion. The upper plate includes an upper plate ring portion and a bridge portion. A lower plate opening is formed in the lower plate. An upper plate opening is formed in the upper plate. At least part of the frame portion is provide below the upper plate opening. At least part of the lower plate opening is provided below the upper plate opening. The bridge portion includes a first through hole and a second through hole into which the first hand shaft and the second hand shaft can be inserted, respectively, and a third through hole formed at a position overlapping with the balance bush in plan view.

The present application is based on, and claims priority from JP Application Serial Number 2022-180450, filed Nov. 10, 2022, the disclosure of which is hereby incorporated by reference herein in its entirety.

### BACKGROUND

### 1. Technical Field

The present disclosure relates to a timepiece.

### 2. Related Art

JP-A-2002-196086 discloses a timepiece including a decoration dial including a base plate and a decoration plate that is provided to at least one of an upper surface and a lower surface of the base plate. The base plate includes at least one or more openings or transparent portions, and the decoration plate includes a decoration portion such as a notch and a window. The opening or the like that is formed on the base plate and the decoration portion formed on the decoration plate are formed in a similar size at the substantially same position in plan view, and a part of a movement, a ruby of a jeweled bush, or the like can visually recognized through the opening and the decoration portion as design features.

Parts of the base plate and the decoration plate other than the opening and the decoration portion are formed into a flat plate-like shape. Thus, only the base plate or the decoration plate that is arranged on the uppermost layer is exposed. As a result, design variations of the dial are limited.

### SUMMARY

According to the present disclosure, a timepiece a movement including a plurality of timepiece components, and a dial being provided above the movement, wherein the movement includes a first hand shaft to which a first hand is attached, a second hand shaft to which a second hand is attached, an escapement speed control mechanism including a balance and a balance bush configured to support the balance pivotally, the dial includes a lower plate and an upper plate provided on the lower plate, the lower plate includes a lower plate ring portion provided along an outer circumference, a frame portion coupled to an inner circumference of the lower plate ring portion, the upper plate includes an upper plate ring portion provided along an outer circumference, a bridge portion coupled to an inner circumference of the upper plate ring portion, a lower plate opening is formed in the lower plate, the lower plate opening being defined by the lower plate ring portion and the frame portion, an upper plate opening is formed in the upper plate, the upper plate opening being defined by the upper plate ring portion and the bridge portion, at least part of the frame portion is provided below the upper plate opening, at least part of the lower plate opening is provided below the upper plate opening, and the bridge portion includes a first through hole and a second through hole into which the first hand shaft and the second hand shaft are insertable, respectively, a third through hole formed at a position overlapping with the balance bush in plan view.

### BRIEF DESCRIPTION OF THE DRAWINGS

FIG. 1 is a plan view illustrating a mechanical timepiece.

FIG. 2 is a cross-sectional view illustrating the mechanical timepiece.

FIG. 3 is a perspective view illustrating main components of the mechanical timepiece.

FIG. 4 is a plan view illustrating a movement of the mechanical timepiece.

FIG. 5 is a plan view illustrating a lower plate of a dial.

FIG. 6 is a plan view illustrating an upper plate of the dial.

FIG. 7 is a plan view illustrating the dial.

FIG. 8 is a plan view illustrating main components of the dial.

FIG. 9 is a plan view illustrating the dial and main components including an hour hand and a minute hand.

### DESCRIPTION OF EMBODIMENTS

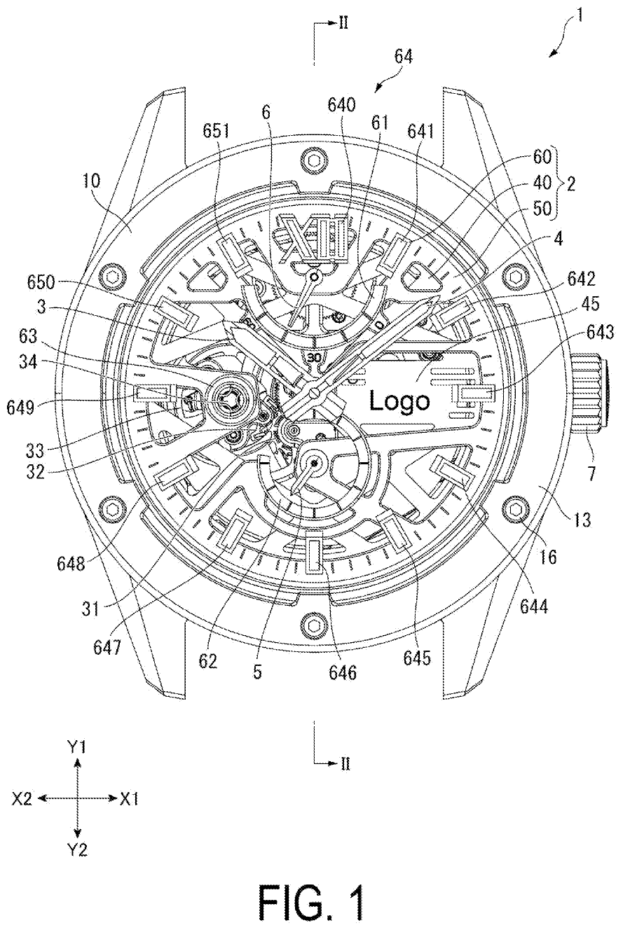

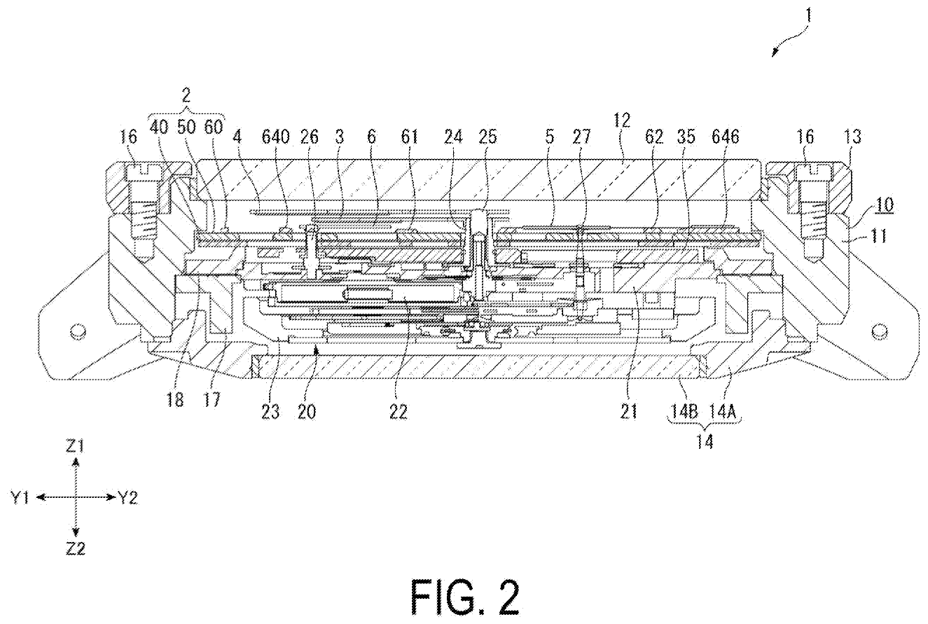

FIG. 1 is a plan view illustrating a timepiece 1, and FIG. 2 is a cross-sectional view taken along the line II-II in FIG. 1. The timepiece 1 is a mechanical timepiece driven by a mainspring, and includes an exterior case 10, a dial 2, an hour hand 3, a minute hand 4, a sub-seconds hand 5, a power reserve hand 6, and a crown 7.

As illustrated in FIG. 2, the exterior case 10 includes a case body 11, a cover glass 12, a bezel 13, and a case back 14. The case back 14 includes an annular case back ring 14A and a case back glass 14B attached inside the case back ring 14A. The bezel 13 is fixed to the case body 11 with a bezel screw 16.

Note that, in the following description, an X axis is an axis parallel to the front surface of the dial 2 of the timepiece 1, and is an axis parallel to a line coupling an hour mark 643 indicating 3 o'clock and an hour mark 649 indicating 9 o'clock on the timepiece 1 to each other. An X1 direction along the X axis is a direction from the hour mark 649 to the hour mark 643, and an X2 direction is a direction opposite to the X1 direction.

A Y axis is an axis that is parallel to the front surface of the dial 2 of the timepiece 1 and is orthogonal to the X axis. A Y1 direction along the Y axis is a direction from an hour mark 646 indicating 6 o'clock to an hour mark 640 indicating 12 o'clock on the timepiece 1, and a Y2 direction is a direction opposite to the Y1 direction.

A Z axis is an axis orthogonal to the X axis and the Y axis. A Z1 direction along the Z axis is a direction from the case back 14 to the cover glass 12 of the timepiece 1, and a Z2 direction is a direction opposite to the Z1 direction. In the following description, a Z1 direction indicates an upper side, and a Z2 direction indicates a lower side. Further, in each component, a surface on the side in the Z1 direction is referred to as an upper surface or a front surface, a surface on the side in the Z2 direction is referred to as a lower surface or a back surface.

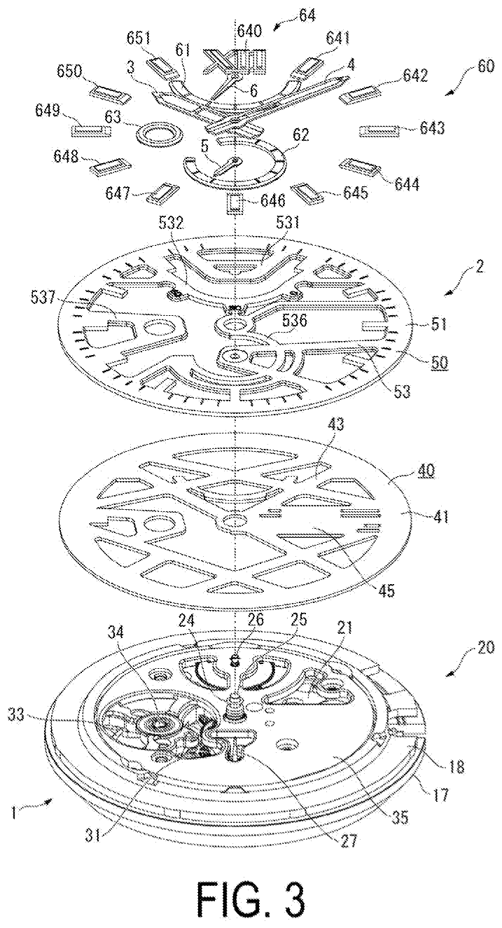

As illustrated in FIG. 2 and FIG. 3, in the exterior case 10, a dial support ring 17 is arranged along an inner circumferential surface of the exterior case 10, and a retaining ring 18 is arranged on the upper surface side of the dial support ring 17. On the inner side of the dial support ring 17 and the retaining ring 18, a mechanical movement 20 is arranged.

The mechanical movement 20 includes a main plate 21 that is held between the dial support ring 17 and the retaining ring 18, a mainspring 22 that functions as a driving source, and an oscillating weight 23 that winds up the mainspring 22. Further, the mechanical movement 20 includes an hour hand shaft 24 to which the hour hand 3 is attached, a minute hand shaft 25 to which the minute hand 4 is attached, a first hand shaft 26 to which the power reserve hand 6 is attached, and a second hand shaft 27 to which the sub-seconds hand 5 is attached.

The hour hand shaft 24 is an hour wheel. The minute hand shaft 25 is inserted into the center shaft part of the hour wheel, and thus the hour hand shaft 24 and the minute hand shaft 25 are arranged coaxially. The hour hand shaft 24 and the minute hand shaft 25 are arranged at the center position of the mechanical movement 20 in plan view, that is, the center position of the dial 2 in plan view.

The first hand shaft 26 is arranged in the 12 o'clock direction with respect to the hour hand shaft 24, and the second hand shaft 27 is arranged in the 6 o'clock direction with respect to the hour hand shaft 24.

The mechanical movement 20 includes an indicator train wheel that transmits a driving force of the mainspring 22 to the hour hand shaft 24, the minute hand shaft 25, and the second hand shaft 27, a power reserve train wheel that drives the first hand shaft 26 in conjunction with winding and rewinding of the mainspring 22, and an escapement speed control mechanism that adjusts a speed of the indicator train wheel. The indicator train wheel and the power reserve train wheel are ones that are generally used in the mechanical movement 20, and hence illustration and description therefor are omitted.

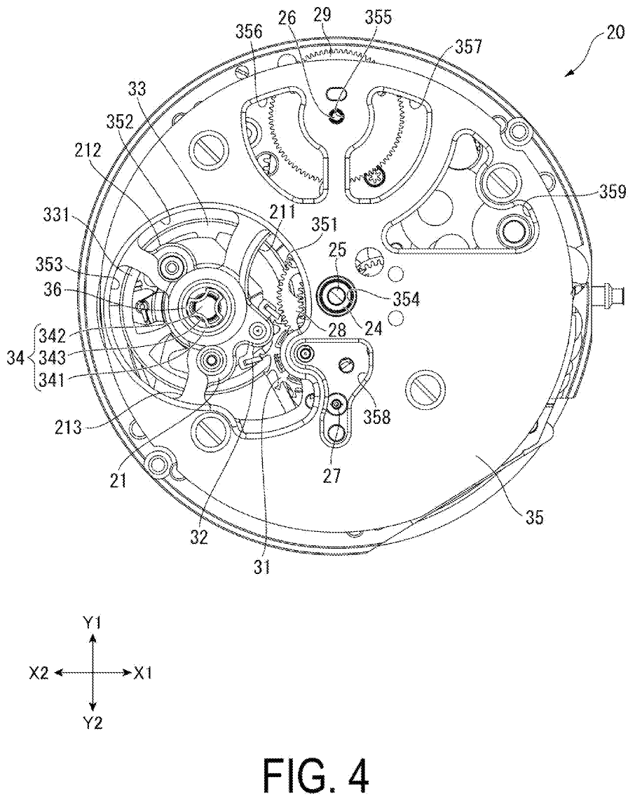

As illustrated in FIG. 1, FIG. 3, and FIG. 4, the escapement speed control mechanism is a general escapement speed control mechanism that includes an escape wheel and pinion 31, the pallet fork 32, a balance 33, a balance bush 34, and the like and adjusts a speed of the indicator train wheel.

The balance 33 is configured to include a balance wheel 331, a balance staff, a hairspring, and the like. As illustrated in FIG. 4, the balance bush 34 is a general shock-absorbing bush, and includes a frame body 341, a hole jewel that is arranged in the frame body 341 and rotatably supports a pivot at an end of the balance staff, a cap jewel 342 that is arranged to face an end of the pivot in the frame body 341, and a cap jeweled sprint 343 for the cap jewel 342. Note that the hole jewel or the cap jewel is configured by a ruby or the like.

The balance bush 34 is provided to each of both ends including an upper end and a lower end of the balance staff. The balance bush 34 on the upper end side is fixed to a portion to which three arms of the main plate 21 are coupled. The balance bush 34 on the lower end side is fixed to a balance bridge body, which is omitted in illustration. Note that the balance bush 34 is arranged in the 9 o'clock direction with respect to the hour hand shaft 24.

In the mechanical movement 20, a setting wheel plate 35 is attached above the main plate 21. The setting wheel plate 35 is provided to hold the components that are arranged on the upper surface side of the main plate 21, such as the hour hand shaft 24 configured by the hour wheel.

As illustrated in FIG. 4, openings through which a portion corresponding to the balance 33 can visually be recognized from the dial 2 side are formed in the main plate 21 and the setting wheel plate 35. In other words, the main plate 21 includes three openings 211, 212, and 213, which are defined by the three arms, above the balance 33 at the positions overlapping with each other in plan view.

The setting wheel plate 35 includes openings 351, 352, and 353 that are arranged on the upper side of the main plate 21 and are defined by the three arms overlapping with the three arms of the main plate 21. The opening 211 and the opening 351, the opening 212 and the opening 352, and opening 213 and the opening 353 are arranged to substantially overlap with each other in plan view.

The openings 211 and 351 are openings for exposing a part of each of the balance wheel 331, the escape wheel and pinion 31, the pallet fork 32, and a toothed gear 28 of the indicator train wheel. The openings 212 and 352 are openings for exposing a part of the balance wheel 331. The openings 213 and 353 are openings for exposing a part of the balance wheel 331 and a part of a stud support 36.

In the setting wheel plate 35, openings 354, 355, 356, 357, 358, and 359 are further formed. The opening 354 is formed at the center of the setting wheel plate 35 in plan view, and is an opening in which the hour hand shaft 24 and the minute hand shaft 25 are arranged. The opening 355 is formed on the 12 o'clock side of the setting wheel plate 35, and is an opening in which the first hand shaft 26 is arranged. The openings 356 and 357 are openings formed on the right side and the left side of the opening 355, and a toothed gear 29 of the power reserve train wheel is exposed therethrough. The opening 358 is formed on the 6 o'clock side of the setting wheel plate 35, and is an opening in which the second hand shaft 27 is arranged. The opening 359 is an opening formed on the 2 o'clock side of the setting wheel plate 35.

Dial

As illustrated in FIG. 2 and FIG. 3, the dial 2 is arranged on the inner circumferential side of the exterior case 10 and above the mechanical movement 20, and is configured to include a lower plate 40, an upper plate 50, and function parts 60.

Lower Plate

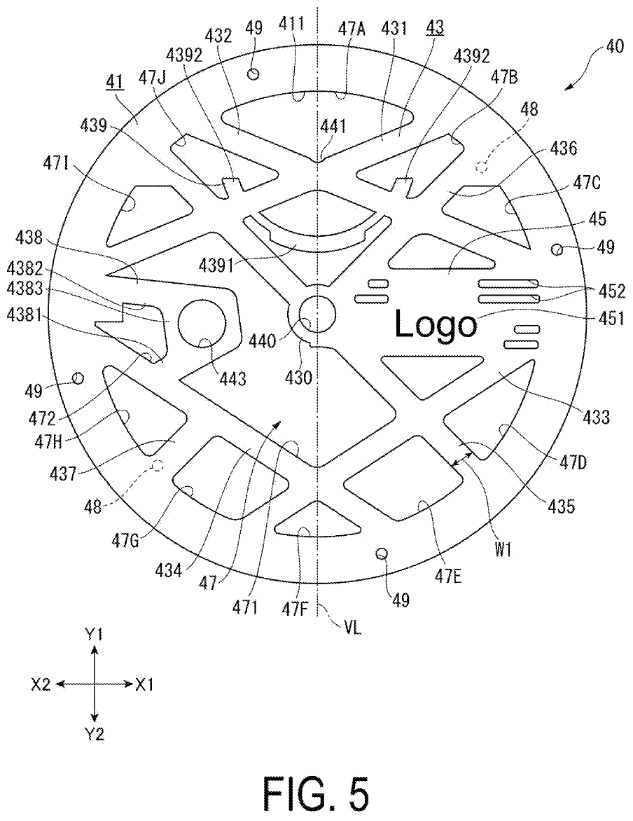

As illustrated in FIG. 5, the lower plate 40 includes a lower plate ring portion 41, a frame portion 43, and a logo display portion 45. The shape and the color of the lower plate 40 are set according to the design of the dial 2. For example, the lower plate 40 may be formed in a dark color such as a black color. The lower plate 40 is formed in a dark color, and thus a sense of depth in the dial 2 is emphasized.

The lower plate ring portion 41 is a circular ring that is provided along the outer circumference of the lower plate 40 and has a constant width dimension. Note that the planar shape of the lower plate ring portion 41 is not limited to a circular shape as long as the lower plate ring portion 41 is configured to include an opening in the inner circumferential portion, and may be a rectangular shape, a barrel-like shape, an oval shape, an octagonal shape, or the like. The lower plate ring portion 41 is only required to be set according to the planar shape of the timepiece 1.

The frame portion 43 is a plate-like member that is coupled to two freely-selected points of an inner circumference 411 of the lower plate ring portion 41 or a plate-like member that is coupled to the inner circumference 411 and another frame portion 43. Moreover, the frame portion 43 may be a plate-like member that is coupled to other two frame portions 43.

The frame portion 43 of the lower plate 40 of the present exemplary embodiment includes a first frame portion 431, a second frame portion 432, a third frame portion 433, a fourth frame portion 434, a fifth frame portion 435, a sixth frame portion 436, a seventh frame portion 437, an eighth frame portion 438, and a ninth frame portion 439. Note that the number of frame portions 43 illustrated in FIG. 5 is nine, but is not limited thereto. The number of frame portions 43 may be eight or less, or may be ten or more. Further, a width dimension of the frame portion 43, for example, a width dimension W1 of the fifth frame portion 435 is smaller than the width dimension of the lower plate ring portion 41. Further, the width dimensions of the first frame portion 431 to the sixth frame portion 436 that are coupled to the lower plate ring portion 41 and have a linear shape are the same dimension W1. The width dimension of the seventh frame portion 437 is a dimension larger than the dimension W1. The width dimension of the ninth frame portion 439 is a dimension smaller than the dimension W1.

The first frame portion 431 is formed into a linear plate-like shape that couples two points at the approximate 1 o'clock position and the approximate 9.5 o'clock position of the inner circumference 411 of the lower plate ring portion 41. The second frame portion 432 is formed into a linear plate-like shape that couples two points at the approximate 11 o'clock position and the approximate 2.5 o'clock position of the inner circumference 411 of the lower plate ring portion 41.

The first frame portion 431 and the second frame portion 432 are arranged to be line-symmetrical to each other with respect to a virtual line VL as an axis of symmetry. The virtual line VL is an axis that passes through the center of the lower plate 40 and is parallel to the Y axis. Further, at an intersection part of the first frame portion 431 and the second frame portion 432, a guide portion 441 having a recess groove shape is formed. The guide portion 441 is formed so as to prevent the first hand shaft 26 from interfering the first frame portion 431 and the second frame portion 432.

The third frame portion 433 is formed into a linear plate-like shape that couples two points at the approximate 3 o'clock position and the approximate 6.5 o'clock position of the inner circumference 411 of the lower plate ring portion 41. The fourth frame portion 434 is formed into a linear plate-like shape that couples two points at the approximate 5.5 o'clock position and the approximate 9 o'clock position of the inner circumference 411 of the lower plate ring portion 41.

The third frame portion 433 and the fourth frame portion 434 are arranged to be line-symmetrical to each other with respect to the virtual line VL as an axis of symmetry.

The fifth frame portion 435 is formed into a linear plate-like shape that couples two points at the approximate 4.5 o'clock position and the approximate 10.5 o'clock position of the inner circumference 411 of the lower plate ring portion 41. The fifth frame portion 435 is formed along the diameter passing through the center of the lower plate 40 in plan view. The fifth frame portion 435 is coupled to the first frame portion 431 and the third frame portion 433 in an intersecting arrangement. Further, at the center of the fifth frame portion 435 in plan view, that is, the center of the lower plate 40 in plan view, a center ring portion 430 is formed. In the center ring portion 430, a through hole 440 into which the hour hand shaft 24 and the minute hand shaft 25 are inserted is formed.

The sixth frame portion 436 is formed into a linear plate-like shape that couples the approximate 1.5 o'clock position and the center ring portion 430 of the inner circumference 411 of the lower plate ring portion 41. The sixth frame portion 436 is arranged to be line-symmetrical to a portion between the approximate 10.5 o'clock position of the fifth frame portion 435 and the center ring portion 430 with respect to the virtual line VL as an axis of symmetry. The sixth frame portion 436 is coupled to the second frame portion 432 in an intersecting arrangement.

The seventh frame portion 437 is formed into a linear plate-like shape that couples the approximate 7.5 o'clock position and the fourth frame portion 434 of the inner circumference 411 of the lower plate ring portion 41. The seventh frame portion 437 is arranged on the extension line of the sixth frame portion 436. Thus, the seventh frame portion 437 is arranged to be line-symmetrical to a part of the fifth frame portion 435 with respect to the virtual line VL as an axis of symmetry.

The eighth frame portion 438 couples the fourth frame portion 434 and the approximate 9 o'clock position of the inner circumference 411 of the lower plate ring portion 41. Thus, the eighth frame portion 438 includes a first extension portion 4381 that extends from the fourth frame portion 434, a second extension portion 4382 that extends from the lower plate ring portion 41, and a coupling portion 4383 that couples the first extension portion 4381 and the second extension portion 4382 to each other. In the coupling portion 4383, a through hole 443 is formed.

The ninth frame portion 439 is formed into an arc shape in plan view, and is coupled to the first frame portion 431 and the second frame portion 432. The ninth frame portion 439 includes an arc part 4391 arranged between an intersection portion of the first frame portion 431 and the second frame portion 432 and the center ring portion 430 and a pair of edge portions 4392 that extend from the first frame portion 431 and the second frame portion 432.

The logo display portion 45 is coupled between the approximate 3 o'clock position and the center ring portion 430 of the inner circumference 411 of the lower plate ring portion 41. Thus, the logo display portion 45 is also coupled to the second frame portion 432, the third frame portion 433, the fifth frame portion 435, and the sixth frame portion 436.

In the logo display portion 45, a logo 451 is displayed. The logo 451 includes a logo type indicating a brand name, a name of a manufacturer, or the like of the timepiece 1, a logo mark for identifying a brand, and the like. The logo 451 may include a plurality of character strings or designs. Further, the logo 451 may be printed on the logo display portion 45. Alternatively, a logo type or a logo mark that is formed into parts may be attached to the front surface of the logo display portion 45. Note that the logo 451 formed into parts may be attached to the logo display portion 45 with an adhesive. Alternatively, a fixing pin is formed on the logo 451, and the logo 451 may be attached by press-fitting the pin into a hole formed in the logo display portion 45.

A plurality of slits 452 are formed in the logo display portion 45. The slits 452 are formed at positions different from the logo 451. The slits 452 are provided for the purpose of design, and the number, the shape, the formation position thereof, or the like may be set as appropriate. Further, the slits 452 are not necessarily provided. The slits 452 may not be required according to the size of the logo display portion 45, the size or the number of the logo 451, or the like.

In the lower plate 40, a plurality of lower plate openings 47 that are defined by the lower plate ring portion 41 and the frame portions 43 are formed.

The lower plate openings 47 include a plurality of lower plate openings including a first lower plate opening 471 and a second lower plate opening 472. The first lower plate opening 471 is formed and defined by the first frame portion 431, the third frame portion 433, the fourth frame portion 434, the fifth frame portion 435, and the eighth frame portion 438. A frame portion is not provided between the center ring portion 430 and the fourth frame portion 434. Thus, the first lower plate opening 471 is formed in a region from the 9 o'clock side to the 6 o'clock side of the center ring portion 430, and has an opening area larger than the other lower plate openings.

The second lower plate opening 472 is defined by the lower plate ring portion 41, the fourth frame portion 434, and the eighth frame portion 438, and is formed on the 9 o'clock side of the through hole 443.

The lower plate openings 47 further include lower plate openings 47A, 47B, 47C, 47D, 47E, 47F, 47G, 47H, 47I, and 47J that are formed between the lower plate ring portion 41 and the frame portions 43. The lower plate openings 47A to 47J are arranged in a clockwise direction from the 12 o'clock position along the inner circumference 411 of the lower plate ring portion 41.

The lower plate openings 47 further include lower plate openings that sandwich the ninth frame portion 439 therebetween and are defined on the 12 o'clock side and the 6 o'clock side and lower plate openings that sandwich the logo display portion 45 therebetween and are defined on the 12 o'clock side and the 6 o'clock side.

The lower plate 40 is fixed to the setting wheel plate 35 of the movement. In other words, on the back surface of the lower plate 40, engagement pins 48 are formed at a plurality of positions. In the setting wheel plate 35, engagement holes (omitted in illustration) into which the pins 48 are press-fitted are formed. In the present exemplary embodiment, the pins 48 are formed at two positions on the diagonal line between the joint part of the sixth frame portion 436 and the lower plate ring portion 41, that is, the approximate 1.5 o'clock position of the lower plate 40 and the joint part of the seventh frame portion 437 and the lower plate ring portion 41, that is, the approximate 7.5 o'clock position of the lower plate 40. Note that the structure for fixing the lower plate 40 to the movement is not limited to the pins 48 and the engagement holes.

In the lower plate 40, engagement holes 49 for fixing the upper plate 50 are formed at four positions.

Upper Plate

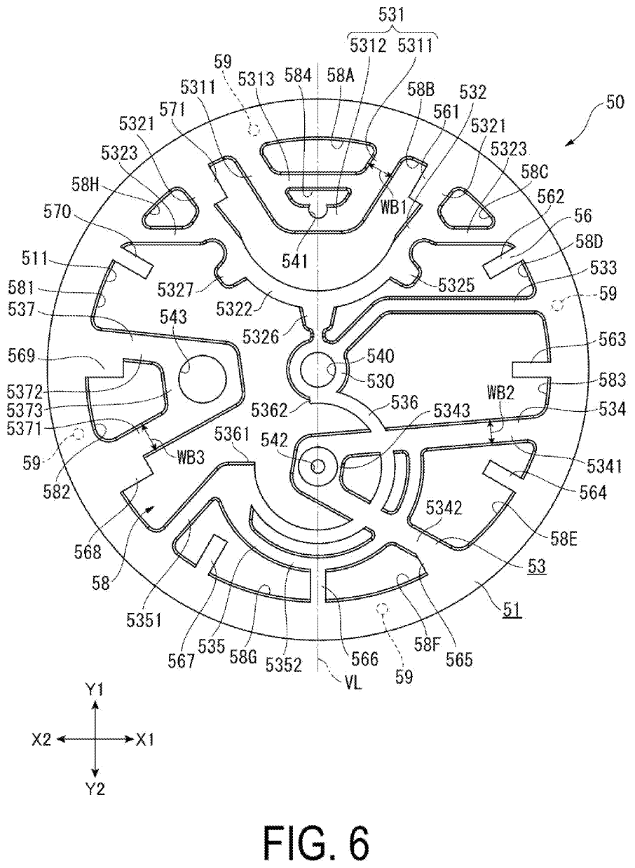

As illustrated in FIG. 6, the upper plate 50 includes an upper plate ring portion 51 and a bridge portion 53. The shape and the color of the upper plate 50 are set according to the design of the dial 2. In particular, the upper plate 50 is formed in a color brighter than the lower plate 40. The lower plate 40 has a darker color, and the upper plate 50 is formed in a color brighter than the lower plate 40. With this, a sense of depth in the dial 2 is emphasized. Further, the upper plate 50 is formed into the same size and shape as the lower plate 40, and is arranged and supported on the upper surface of the lower plate 40.

The upper plate ring portion 51 is a circular ring that is provided along the outer circumference of the upper plate 50 and has a constant width dimension. Note that the upper plate ring portion 51 is not limited to a circular ring in plan view as long as the upper plate ring portion 51 is configured to include an opening in the inner circumferential portion, and may be a rectangular ring in plan view. The upper plate ring portion 51 is formed into the same size and the same shape as the lower plate ring portion 41.

The bridge portion 53 is coupled to an inner circumference 511 of the upper plate ring portion 51. The bridge portion 53 is a plate-like member that is coupled to two freely-selected points of the inner circumference 511, or is coupled to the inner circumference 511 and another bridge portion 53. Moreover, the bridge portion 53 may be coupled to other two bridge portions 53.

The bridge portion 53 of the upper plate 50 of the present exemplary embodiment includes a first bridge portion 531, a second bridge portion 532, a third bridge portion 533, a fourth bridge portion 534, a fifth bridge portion 535, a sixth bridge portion 536, and a seventh bridge portion 537. Note that the number of bridge portions 53 illustrated in FIG. 5 is seven, but is not limited thereto. The number of bridge portions 53 may be six or less, or may be eight or more.

The first bridge portion 531 is formed to couple two points at the approximate 0.5 o'clock position and the approximate 11.5 o'clock position of the inner circumference 511 of the upper plate ring portion 51. In other words, the first bridge portion 531 includes a pair of extension portions 5311 that extend from the inner circumference 511 to the center of the upper plate 50 in plan view and a coupling portion 5312 that couples the distal ends of the extension portions 5311, and is formed into a substantially trapezoidal shape. An auxiliary bridge portion 5313 parallel to the Y-axis direction is provided between the pair of extension portions 5311.

A first through hole 541 is formed in the coupling portion 5312 so that the first hand shaft 26 can be arranged without interfering with the coupling portion 5312. The first through hole 541 is formed into a notched shape that partially passes through an upper plate opening 584. the upper plate opening 584 is defined and formed between the coupling portion 5312 and the auxiliary bridge portion 5313. However, the first through hole 541 may be formed within the flat surface of the coupling portion 5312 without passing through the upper plate opening 584.

The first bridge portion 531 can appear to support the first hand shaft 26 by arranging the first hand shaft 26 in the first through hole 541. Thus, a first support bridge portion is configured by the first bridge portion 531.

The second bridge portion 532 is formed to couple two points at the approximate 1 o'clock position and the approximate 11 o'clock position of the inner circumference 511 of the upper plate ring portion 51. In other words, the second bridge portion 532 includes a pair of extension portions 5321 that extend from the inner circumference 511 to the center of the upper plate 50 in plan view and an arc portion 5322 that couples the pair of extension portions 5321. Further, the second bridge portion 532 includes a pair of auxiliary bridge portions 5323 that couples the pair of extension portions 5321 and the inner circumference 511. Further, three protrusion portions 5325, 5326, and 5327 protrude from the arc portion 5322 of the second bridge portion 532.

The protrusion portion 5326 formed on the virtual line VL is coupled to a center ring portion 530 formed at the center of the upper plate 50 in plan view. In the center ring portion 530, a through hole 540 into which the hour hand shaft 24 and the minute hand shaft 25 are inserted is formed.

The third bridge portion 533 extends from the approximate 2.5 o'clock position of the inner circumference 511 of the upper plate ring portion 51, and the distal end side thereof is coupled to the center ring portion 530. The third bridge portion 533 extends from the inner circumference 511 in a direction parallel to the Y-axis direction, and further extends to the center ring portion 530 in an oblique direction with respect to the X axis and the Y axis.

The fourth bridge portion 534 is formed to couple the approximate 3.5 o'clock position and the approximate 5 o'clock position of the inner circumference 511 of the upper plate ring portion 51. In other words, the fourth bridge portion 534 includes a first plate portion 5341, a second plate portion 5342, and a coupling portion 5343. The first plate portion 5341 is formed to have a substantially V-like shape in plan view, and extends substantially along the Y-axis direction from the approximate 3.5 o'clock position of the inner circumference 511 to the position of the virtual line VL. The second plate portion 5342 extends from the approximate 5 o'clock position of the inner circumference 511 to the position of the virtual line VL. The coupling portion 5343 couples the distal ends of the first plate portion 5341 and the second plate portion 5342.

In the coupling portion 5343 of the fourth bridge portion 534 that overlaps with the virtual line VL, a second through hole 542 in which the second hand shaft 27 can be arranged is formed. The fourth bridge portion 534 can appear to support the second hand shaft 27 by arranging the second hand shaft 27 in the second through hole 542. Thus, a second support bridge portion is configured by the fourth bridge portion 534.

The fifth bridge portion 535 is formed to couple the approximate 7.5 o'clock position of the inner circumference 511 of the upper plate ring portion 51 and the fourth bridge portion 534. In other words, the fifth bridge portion 535 includes an extension portion 5351 that extends from the inner circumference 511 to the center ring portion 530 and an arc portion 5352. The arc portion 5352 is coupled to the first plate portion 5341 and the second plate portion 5342 in an intersecting manner.

The sixth bridge portion 536 is arranged on the inner circumferential side of the arc portion 5352 of the fifth bridge portion 535, and is formed to couple the extension portion 5351 and the center ring portion 530. The sixth bridge portion 536 is also coupled to the first plate portion 5341 and the second plate portion 5342 in an intersecting manner.

A central angle of an arc from an edge 5361 of the sixth bridge portion 536 on the extension portion 5351 side to an edge 5362 thereof on the center ring portion 530 is approximately 280 degrees. A portion from the edge 5361 to the edge 5362 in a clockwise direction corresponds to an opening portion in which the sixth bridge portion 536 is not provided.

The seventh bridge portion 537 is formed to couple the approximate eight o'clock position and the approximate 9 o'clock position of the inner circumference 511 of the upper plate ring portion 51. In other words, the seventh bridge portion 537 includes the extension portion 5371, the extension portion 5372, and the coupling portion 5373. The extension portion 5371 extends from the approximate eight o'clock position of the inner circumference 511 to the center side of the upper plate 50 in plan view. The extension portion 5372 extends from the approximate 9 o'clock position of the inner circumference 511 to the center side of the upper plate 50 in plan view. The coupling portion 5373 couples the distal ends of the extension portion 5371 and the extension portion 5372. In the coupling portion 5373, a third through hole 543 positioned above the balance bush 34 is formed.

The seventh bridge portion 537 can appear to support the balance bush 34 by arranging the third through hole 543 above the balance bush 34. Thus, a third support bridge portion is configured by the seventh bridge portion 537.

Width dimensions WB1, WB2, and WB3 of the first bridge portion 531 being the first bridge portion, the fourth bridge portion 534 being the second bridge portion, and the seventh bridge portion 537 being the third bridge portion are set to be larger than the width dimensions of the second bridge portion 532, the third bridge portion 533, the fifth bridge portion 535, and the sixth bridge portion 536 being the other bridge portions. Thus, the design in which the first hand shaft 26, the second hand shaft 27, and the balance bush 34 are supported stably can be achieved.

Moreover, the width dimensions WB1, WB2, and WB3 of the first bridge portion 531, the fourth bridge portion 534, and the seventh bridge portion 537 are larger than the width dimension W1 of the first frame portion 431 to the sixth frame portion 436 of the lower plate 40, and the width dimensions of the other bridge portions are smaller than the dimension W1.

A support piece portion 56 that supports an hour mark, which is described later, is formed on the upper plate 50. As described later, the support piece portion 56 includes a first support piece portion 561, a second support piece portion 562, a third support piece portion 563, a fourth support piece portion 564, a fifth support piece portion 565, a sixth support piece portion 566, a seventh support piece portion 567, an eighth support piece portion 568, a ninth support piece portion 569, a tenth support piece portion 570, and an eleventh support piece portion 571 that are formed at the respective corresponding positions from 1 o'clock to 11 o'clock.

The first support piece portion 561 is formed continuously with the extension portions 5321. The fifth support piece portion 565 is formed continuously with the second plate portion 5342 of the fourth bridge portion 534. The inner circumferential side of the sixth support piece portion 566 is coupled to the arc portion 5352.

The eighth support piece portion 568 is formed continuously with the extension portion 5371, and the ninth support piece portion 569 is formed continuously with the extension portion 5372. The eleventh support piece portion 571 is formed continuously with the extension portions 5321.

In the upper plate 50, a plurality of upper plate openings 58 that are defined by the upper plate ring portion 51 and the bridge portions 53 are formed.

The upper plate openings 58 include a plurality of upper plate openings including a first upper plate opening 581, a second upper plate opening 582, and a third upper plate opening 583. The first upper plate opening 581 is formed and defined by the upper plate ring portion 51, the second bridge portion 532, the center ring portion 530, the fourth bridge portion 534, the fifth bridge portion 535, the sixth bridge portion 536, and the seventh bridge portion 537. In other words, the upper plate openings 58 are openings that are mainly formed in the region of the 9 o'clock side of the virtual line VL. The second upper plate opening 582 is defined by the upper plate ring portion 51 and the seventh bridge portion 537, and is formed at the 9 o'clock position of the upper plate 50.

The third upper plate opening 583 is an opening that is defined by the upper plate ring portion 51, the third bridge portion 533, the center ring portion 530, the fourth bridge portion 534, and the sixth bridge portion 536 and is formed in the region of the 3 o'clock side of the virtual line VL.

The upper plate openings 58 further include upper plate openings 58A, 58B, 58C, 58D, 58E, 58F, 58G, and 58H that are formed between the upper plate ring portion 51 and the bridge portions 53. The upper plate openings 58A to 58H are arranged from the 12 o'clock position in a clockwise direction along the inner circumference of the upper plate ring portion 51.

The upper plate openings 58 include the upper plate opening 584 that is defined between the coupling portion 5312 and the auxiliary bridge portion 5313. Further, the upper plate openings 58 are also formed between the fifth bridge portion 535 and the sixth bridge portion 536 and between the coupling portion 5343 of the fourth bridge portion 534 and the sixth bridge portion 536.

The upper plate 50 is fixed to the lower plate 40. In other words, engagement pins 59 are formed at a plurality of positions on the back surface of the upper plate 50, and the engagement holes 49 into which the pins 59 are press-fitted are formed in the lower plate 40. In the present exemplary embodiment, the four pins 59 are formed at an equal interval in the circumferential direction on the lower surface of the upper plate ring portion 51. In the lower plate 40, the four engagement holes 49 are formed. However, another configuration may be adopted as the configuration of fixing the upper plate 50 to the lower plate 40.

Function Parts

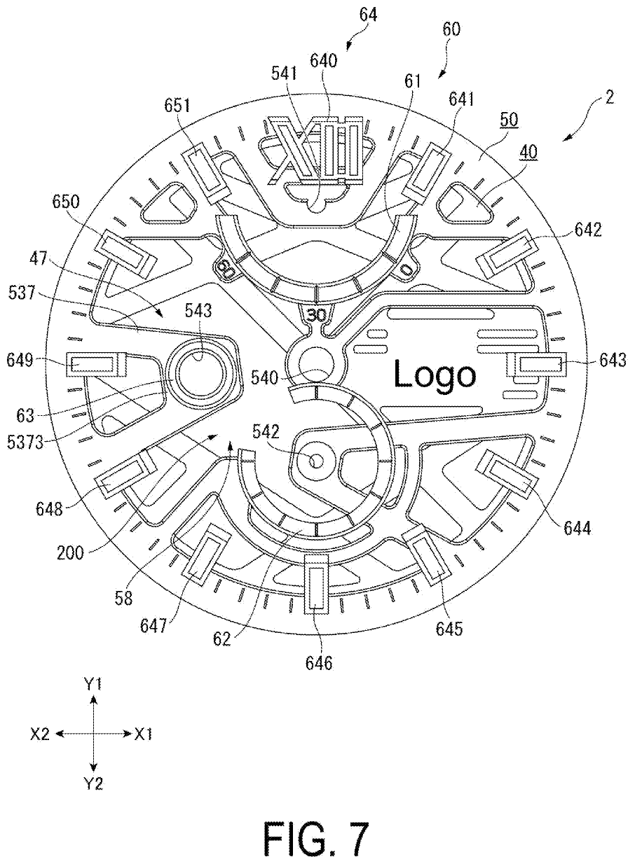

As illustrated in FIG. 3 and FIG. 7, the plurality of function parts 60 are attached on the front surface of the upper plate 50. The function parts 60 are attached on the upper plate 50 by an attachment mechanism, which is omitted in illustration. For example, as the attachment mechanism, a mechanism in which attachment protrusions formed on the function parts 60 are press-fixed into attachment holes formed in the upper plate 50 may be used. Further, the function parts 60 may be attached to the upper plate 50 by an adhesive.

The function parts 60 includes a power reserve mark 61 being a power reserve indicator part, a sub dial mark 62 being a sub-seconds hand indicator part, a decoration ring 63, and an hour mark 64. The hour mark 64 is also referred to as an hour character or an index. In the present exemplary embodiment, the hour mark 64 includes an hour mark 640 being a Roman numeral provided at the 12 o'clock position and bar-shaped hour marks 641 to 651 provided at the 1 o'clock position to the 11 o'clock position, respectively.

The hour mark 640 is arranged and attached over the upper plate ring portion 51 and the auxiliary bridge portion 5313.

The hour marks 641, 642, 643, 644, 645, 646, 647, 648, 649, 650, and 651 are attached to the first support piece portion 561, the second support piece portion 562, the third support piece portion 563, the fourth support piece portion 564, the fifth support piece portion 565, the sixth support piece portion 566, the seventh support piece portion 567, the eighth support piece portion 568, the ninth support piece portion 569, the tenth support piece portion 570, the eleventh support piece portion 571, respectively.

The power reserve mark 61 is an indicator that indicates a remaining drive time of the timepiece 1 with the power reserve hand 6. The power reserve mark 61 is attached to the arc portion 5322 of the second bridge portion 532. Further, as illustrated in FIG. 7, in the protrusion portions 5325, 5326, and 5327, Arabic numerals indicating contexts of the indicators provided to the power reserve mark 61 are shown. In other words, the protrusion portion 5325 displays “0” indicating that the remaining drive time is zero hours. The protrusion portion 5326 displays “30” indicating that the remaining drive time is 30 hours. The protrusion portion 5327 displays “60” indicating that the remaining drive time is 60 hours. Those Arabic numerals are printed on the protrusion portions 5325, 5326, and 5327 or created as parts to be attached by an adhesive or the like, and thus are displayed.

The sub dial mark 62 is an indicator indicating seconds of the time with the sub-seconds hand 5. The sub dial mark 62 is attached to the sixth bridge portion 536. Thus, the sixth bridge portion 536 is a support portion that supports the sub dial mark 62. Note that the sub-seconds hand 5 is set to perform one rotation, that is, 360 degrees in 60 seconds. Thus, on the sub dial mark 62, indicators are formed at an interval of 30 degrees from the 12 o'clock position side as a starting point. The sub dial mark 62 is configured to indicate seconds in intervals of five seconds with those indicators.

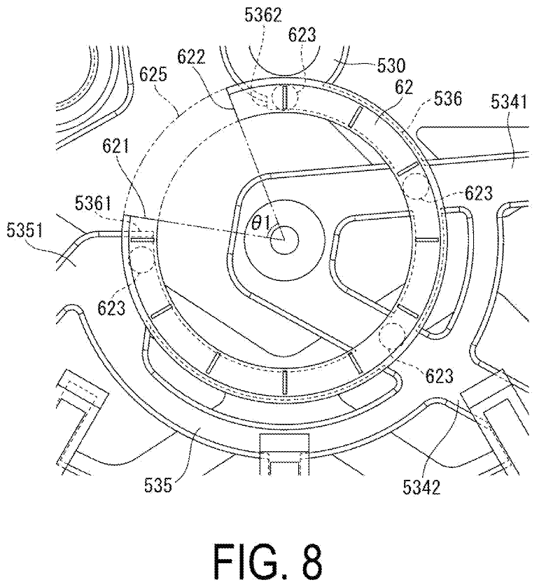

Further, also as illustrated in FIG. 8, a notch portion 625 is formed in a part of the outer circumference of the sub dial mark 62, and the sub dial mark 62 is formed into a substantially C-like shape in plan view. Specifically, the notch portion 625 is formed in a portion corresponding to an opening portion between the edges 5361 and 5362 of the sixth bridge portion 536. The notch portion 625 is formed within a range of a central angle θ1=60 degrees, and the sub dial mark 62 is formed into an arc shape having a central angle of 300 degrees.

Note that, when the 12 o'clock direction of the dial 2 is regarded as a 0 seconds position (0 degrees), the sub dial mark 62 of the present exemplary embodiment is formed within a range from 0 to 46.5 seconds (0 to 279 degrees) and a range from 56.5 to 60 seconds (339 to 360 degrees), and a range corresponding to 10 seconds from 46.5 to 56.5 seconds (60 degrees from 279 to 339 degrees) is cut out to form the notch portion 625.

The sub dial mark 62 is not formed into a ring, but is formed into a substantially C-like shape by forming the notch portion 625. Thus, as illustrated in FIG. 1, visibility of the timepiece components such as the escape wheel and pinion 31 and the pallet fork 32 through the opening portions of the dial 2 and the setting wheel plate 35 can be improved.

In other words, when the sub dial mark 62 is attached to the dial 2 of a skeleton type through which the timepiece components such as the escape wheel and pinion 31 in the timepiece movement can be visually recognized, the sub dial mark 62 may be partially cut off and formed into a substantially C-like shape so as to improve visibility of the timepiece components. Meanwhile, when the angle range of the notch portion of the sub dial mark 62 is increased more than the movement angle range of the sub-seconds hand 5, that is, 360 degrees, a range in which the sub-seconds hand 5 cannot point at an indicator is increased to degrade indicator visibility. Therefore, there is demanded a structure that can improve visibility of the timepiece components such as the escape wheel and pinion 31 while suppressing the notch angle range to a constant range or less.

Moreover, on the dial 2, it is required to arrange the first upper plate opening 581 of the dial 2 in a portion corresponding to the notch portion of the notch portion of the sub dial mark 62. Further, in order to improve the design of the dial 2, it is required to increase the opening area in the dial 2 through which the timepiece components can visually be recognized and improve the design of the dial 2.

Thus, in the present exemplary embodiment, the sub dial mark 62 is formed into an arc shape having the central angle of 300 degrees. In 60 seconds during which the sub-seconds hand 5 performs one rotation, the sub-seconds hand 5 points at the sub dial mark 62 for 50 seconds, and the sub-seconds hand 5 points at the notch portion 625 of the sub dial mark 62 only for 10 seconds. With this, indicator visibility is secured. Further, the notch portion of the sub dial mark 62 is arranged to overlap with the portion corresponding to the first upper plate opening 581 between the edges of the sixth bridge portion 536. Thus, visibility of the escape wheel and pinion 31 and the pallet fork 32 can be improved.

Further, edges 621 and 622 of the sub dial mark 62 on the notch portion 625 side slightly protrude from the sixth bridge portion 536. In the present exemplary embodiment, a protrusion dimension from the edges 5361 and 5362 of the sixth bridge portion 536 to the edges 621 and 622 of the sub dial mark 62 is set to 2 mm or smaller, for example, 1.5 mm.

The sub dial mark 62 includes fixing pins 623 that protrude from the back surface. In the present exemplary embodiment, as illustrated in FIG. 8, the pins 623 are formed at four positions. Specifically, the pins 623 are formed at the 12 o'clock position, the approximate 2 o'clock position, the approximate 4 o'clock position, and the approximate 9 o'clock position of the sub dial mark 62, respectively.

Although omitted in illustration, fixing holes into which the pins 623 of the sub dial mark 62 are press-fixed are formed in the upper plate 50. The fixing holes are formed at four positions including a coupling portion of the sixth bridge portion 536 and the center ring portion 530 that corresponds to the 12 o'clock position of the sub dial mark 62, an intersection portion of the sixth bridge portion 536 and the first plate portion 5341 that corresponds to the approximate 2 o'clock position of the sub dial mark 62, an intersection portion of the sixth bridge portion 536 and the second plate portion 5342 that corresponds to the approximate 4 o'clock position of the sub dial mark 62, and a coupling portion of the sixth bridge portion 536 and the extension portion 5351 that corresponds to the approximate 9 o'clock position of the sub dial mark 62.

The positions and number of the pins 623 of the sub dial mark 62 are not limited to those illustrated in FIG. 8. In other words, the pins 623 may be formed at two or more positions. The formation positions thereof are only required to be within the range of the sixth bridge portion 536, that is, the positions at which the fixing holes can be formed. However, as illustrated in FIG. 8, when the fixing holes are formed at the coupling portions of the sixth bridge portion 536 and the other bridge portions, the fixing holes are easily processed. Thus, fixing strength is advantageously improved.

Further, the pins 623 are formed at the 12 o'clock position and the approximate 9 o'clock position of the sub dial mark 62. Thus, the dimension from those pins 623 to the edges 621 and 622 is set to 2.5 mm or smaller. Thus, even when an impact is applied by the act of dropping the timepiece 1 on the ground or the like, displacement of the portions corresponding to the edges 621 and 622 can be suppressed.

The decoration ring 63 is provided to make the cap jewel 342 of the balance bush 34 noticeable. As illustrated in FIG. 7, the decoration ring 63 is attached to the coupling portion 5373 of the seventh bridge portion 537. The decoration ring 63 is formed into an annular shape, and the center axial portion is formed as a through hole. The through hole is arranged to overlap with the third through hole 543 formed in the coupling portion 5373, and an inner circumferential surface of the decoration ring 63 is arranged along the outer circumference of the third through hole 543. Thus, as illustrated in FIG. 1, the balance bush 34 can visually be recognized from above the dial 2 from the through hole of the decoration ring 63 through the third through hole 543 of the upper plate 50 and the through hole 443 of the lower plate 40.

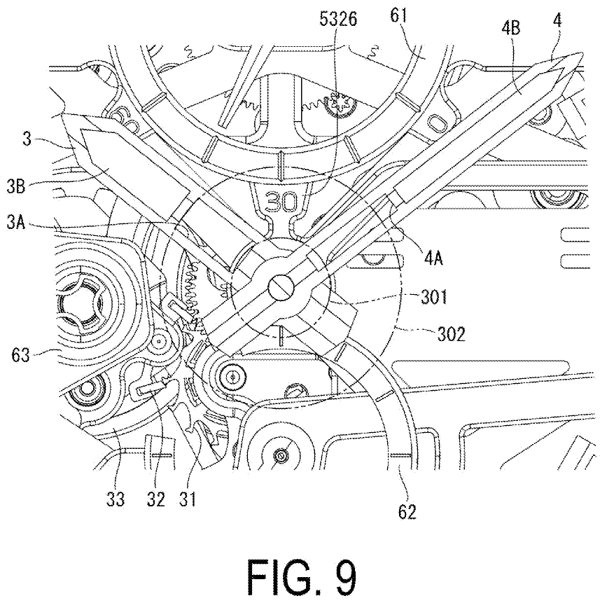

As illustrated in FIG. 9, notch regions 3A and 4A are formed in the hour hand 3 and the minute hand 4 on base end sides close to the hour hand shaft 24 and the minute hand shaft 25, and luminous regions 3B and 4B to which a luminous coating is applied are provided on the distal end sides with respect to the notch region 3A.

The notch region 3A of the hour hand 3 is formed into a rectangular shape in plan view, and a movement locus of the notch region 3A at the time of operating the hour hand 3 is a band-like region surrounded by two-dot chain lines 301 and 302 in FIG. 9. Thus, during operation of the hour hand 3, the escape wheel and pinion 31, the pallet fork 32, the sub dial mark 62, the numeral on the protrusion portion 5326, and the like can also be visually recognized through the notch region 3A.

the notch region 4A of the minute hand 4 is formed into a rectangular shape in plan view, and a movement locus of the notch region 4A is wider than the movement locus of the notch region 3A in the radial direction. Thus, similarly to the notch region 3A, the escape wheel and pinion 31 and the like can also be visually recognized during operation of the minute hand 4.

As described above, the dial 2 is acquired by attaching the upper plate 50 to the upper surface of the lower plate 40 in an overlapping manner. In the upper plate 50, the upper plate opening 58 defined by the bridge portion 53 is formed. Through the upper plate opening 58, the frame portion 43 of the lower plate 40 is partially exposed. Thus, as illustrated in FIG. 7, when the dial 2 is visually recognized from above, the frame portion 43 can visually recognized in addition to the bridge portion 53 of the upper plate 50. In this manner, the frame portion 43 and the bridge portion 53 are formed on the two plates including the lower plate 40 and the upper plate 50, respectively, and the frame portion 43 and the bridge portion 53 are positioned in an intersecting arrangement so as to partially overlap. With this, the design with a sense of depth can be formed, and variations of the design of the dial 2 can be increased.

The lower plate openings 47 of the lower plate 40 and the upper plate opening 58 of the upper plate 50 overlap with each other in plan view. With this, in the dial 2, a dial opening 200 passing through the dial 2 in the Z-axis direction is formed.

Through the dial opening 200, the setting wheel plate 35 positioned below the dial 2 and the timepiece components that can visually recognized through the setting wheel plate 35 and the opening of the main plate 21 can visually recognized. In the present exemplary embodiment, the escape wheel and pinion 31, the pallet fork 32, the balance 33, the toothed gear 28, and the like of the mechanical movement 20 can be visually recognized.

### Effects of Exemplary Embodiment

The lower plate 40 including the lower plate ring portion 41 and the frame portion 43 and the upper plate 50 including the upper plate ring portion 51 and the bridge portion 53 overlap with each other to form the dial 2. Moreover, at least a part of the frame portion 43 is arranged below the upper plate opening 58, and hence a part of the frame portion 43 is not covered with the bridge portion 53 but is exposed. Thus, on the dial 2, the bridge portion 53 and the frame portion 43 having different depths can be visually recognized. Thus, the design variation of the dial 2 can be improved.

Moreover, the first through hole 541, the second through hole 542, and the third through hole 543 are formed in the bridge portions 53 of the upper plate 50. The first hand shaft 26 is arranged in the first through hole 541, the second hand shaft 27 is arranged in the second through hole 542, and the third through hole 543 is arranged above the balance bush 34. Thus, at the time of visually recognizing the dial 2 of the timepiece 1, the first hand shaft 26, the second hand shaft 27, and the balance bush 34 appear to be supported on the bridge portions 53. Thus, the first hand shaft 26, the second hand shaft 27, and the balance bush 34 appear to be supported stably. The design of the timepiece 1 of a skeleton type can be improved.

The logo display portion 45 for displaying the logo 451 is formed on the lower plate 40 so that the logo display portion 45 can visually be recognized through the third upper plate opening 583. Thus, the logo display portion 45 can be arranged at the depth position in the dial 2. Thus, the logo 451 displayed in the logo display portion 45 can be displayed sophisticatedly without being excessively noticeable, and the design can be improved.

The function parts 60 is attached to the front surface of the upper plate 50. Thus, a three-dimensional effect of the dial 2 can further be emphasized, and the design of the dial 2 can be improved.

The power reserve mark 61 being a power reserve indicator part for displaying the indicator of the power reserve hand 6 and the sub dial mark 62 being the sub-seconds hand indicator part for displaying the indicator of the sub-seconds hand 5 are provided as the function parts 60. Thus, visibility of the indication positions of the power reserve hand 6 and the sub-seconds hand 5 can be improved. Further, the hour mark 64 indicated by the hour hand 3 and the minute hand 4 is a function part, and hence the design of the dial 2 can be improved. Moreover, the decoration ring 63 that surrounds the periphery of the balance bush 34 is provided as a function part. Thus, the cap jewel 342 formed of a ruby is noticeable, and the design can be improved.

The width dimension WB1 of the first bridge portion 531 being the first bridge portion, the width dimension WB2 of the fourth bridge portion 534 being the second bridge portion, and the width dimension WB3 of the seventh bridge portion 537 being the third bridge portion are larger than those of the other bridge portions. Thus, the design in which the first hand shaft 26, the second hand shaft 27, and the balance bush 34 appear to be supported stably can be achieved.

On the dial 2, the power reserve hand 6 is arranged at the 12 o'clock position, the sub-seconds hand 5 is arranged at the 6 o'clock position, the balance bush 34 is arranged at the 9 o'clock position, and the logo display portion 45 is arranged at the 3 o'clock position. Thus, those components are arranged in a well-balanced manner, and the design of the timepiece 1 can further be improved.

On the lower plate 40, the first frame portion 431 to the eighth frame portion 438 other than the ninth frame portion 439 formed into an arc shape are mainly formed linearly, for example, a linear plate-like shape as a design. Thus, the powerful design can be achieved. Further, on the upper plate 50, the first bridge portion 531 to the seventh bridge portion 537 other than the sixth bridge portion 536 formed into an arc shape, particularly, the portions protruding from the upper plate ring portion 51 are also mainly formed linearly as a design. Thus, the powerful design can be achieved similarly.

Moreover, the frame portions 43 of the lower plate 40 and the bridge portions 53 of the upper plate 50 are designed to intersect with each other in a complex manner in an overlapping arrangement. Thus, the design with excellent designability such as complexity and a three-dimensional effect can be achieved. Moreover, the bridge portion 53 can appear to be supported by the frame portion 43. The design with a sense of stability and weightiness can be achieved.

When the dial 2 is viewed in plan view, an area in which the upper plate 50 is exposed, an area in which the lower plate 40 is exposed, and an area in which the mechanical movement 20 is exposed are well balanced. Thus, the design of the timepiece 1 of a full-skeleton type can be improved.

The colors of the upper plate 50 and the lower plate 40 are different from each other. With this, the design variations of the dial 2 can be increased. For example, when the upper plate 50 and the lower plate 40 are colored in gray and dark gray, the dial 2 can be configured with a black theme. Further, when the upper plate 50 and the lower plate 40 are colored in silver and light gray, the dial 2 can be configured with a white theme. Moreover, the brightness of the colors of the upper plate 50 and the lower plate 40 is adjusted, and thus various designs, for example, an emphasis on a sense of depth in the dial 2, can be achieved. Moreover, the color tone of the structure of the mechanical movement 20 that can visually be recognized through the dial 2, for example, the setting wheel plate 35 is also set as appropriate. With this, the design variations can further be increased.

the second bridge portion 532 of the upper plate 50 to which the power reserve mark 61 is attached is coupled to the upper plate ring portion 51 via the extension portions 5321 and the auxiliary bridge portions 5323 that are branched into two, and is further coupled to the center ring portion 530 via the protrusion portion 5326. Thus, rigidity can be improved. Even when an impact is applied to the timepiece 1, deformation is less likely to be caused. Therefore, attachment strength of the power reserve mark 61 can be improved. Moreover, the ninth frame portion 439 of the lower plate 40 is provided below the second bridge portion 532, and the first frame portion 431 and a part of the second frame portion 432 are also provided. Thus, deformation of the second bridge portion 532 can further be suppressed.

Both the end portions of the sixth bridge portion 536 of the upper plate 50 to which the sub dial mark 62 is attached are coupled to the fifth bridge portion 535 and the center ring portion 530. In addition to this, the intermediate portion thereof is coupled to the first plate portion 5341 and the second plate portion 5342 of the fourth bridge portion 534. Thus, rigidity can be improved. Even when an impact is applied to the timepiece 1, deformation is less likely to be caused. Therefore, attachment strength of the sub dial mark 62 can also be improved.

The edges 621 and 622 of the sub dial mark 62 are not supported by the sixth bridge portion 536. However, the sixth bridge portion 536 supports 90% or more of the sub dial mark 62 in the circumferential direction. Thus, attachment strength of the sub dial mark 62 can sufficiently be secured.

Further, the sixth bridge portion 536 does not protrude from the edges 621 and 622 of the sub dial mark 62. Thus, the notch portion 625 can be secured, and degradation of visibility of the timepiece components can be prevented.

The seventh bridge portion 537 of the upper plate 50 to which the decoration ring 63 is attached supports the coupling portion 5373 to which the decoration ring 63 is attached, with the two extension portions 5371 and 5372. Thus, rigidity can be improved, and attachment strength of the decoration ring 63 can also be improved. Moreover, the eighth frame portion 438 of the lower plate 40 is arranged below the seventh bridge portion 537. Thus, deformation of the seventh bridge portion 537 can further be suppressed.

### Modification Example

The lower plate 40 is not limited to one including the logo display portion 45 having a flat plate-like shape. For example, a frame portion for attaching a logo part to the lower plate 40 may be provided, or a bridge portion for attaching a logo part to the upper plate 50 may be provided.

The first hand and the second hand are not limited to the power reserve hand 6 and the sub-seconds hand 5, and may be a moon phase indicator hand, a date indicator hand, a counting hand, and the like.

Overview of Present Disclosure

According to the present disclosure, a timepiece a movement including a plurality of timepiece components, and a dial being provided above the movement, wherein the movement includes a first hand shaft to which a first hand is attached, a second hand shaft to which a second hand is attached, an escapement speed control mechanism including a balance and a balance bush configured to support the balance pivotally, the dial includes a lower plate and an upper plate provided on the lower plate, the lower plate includes a lower plate ring portion provided along an outer circumference, a frame portion coupled to an inner circumference of the lower plate ring portion, the upper plate includes an upper plate ring portion provided along an outer circumference, a bridge portion coupled to an inner circumference of the upper plate ring portion, a lower plate opening is formed in the lower plate, the lower plate opening being defined by the lower plate ring portion and the frame portion, an upper plate opening is formed in the upper plate, the upper plate opening being defined by the upper plate ring portion and the bridge portion, at least part of the frame portion is provided below the upper plate opening, at least part of the lower plate opening is provided below the upper plate opening, and the bridge portion includes a first through hole and a second through hole into which the first hand shaft and the second hand shaft are insertable, respectively, a third through hole formed at a position overlapping with the balance bush in plan view.

The dial of the timepiece is formed by overlapping the lower plate including the lower plate ring portion and the frame portion and the upper plate including the upper plate ring portion and the bridge portion. Thus, the dial of a skeleton type can be formed. Further, at least a part of the frame portion is provided below the upper plate opening. Thus, a part of the frame portion is not covered with the bridge portion, but is exposed. Thus, on the dial, the bridge portion and the frame portion having different depths can be visually recognized. Thus, the design variation of the dial can be improved.

Moreover, in the bridge portions of the upper plate, the first to third through holes are formed. The first and second hand shafts are arranged in the first and second through holes, and the third through hole is arranged above the balance bush. Thus, at the time of visually recognizing the dial of the timepiece, the design in which the first and second hand shafts and the balance bush appear to be supported on the bridge portions. Thus, each of the hand shafts and the balance bush appear to be supported stably, and the design of the timepiece of a skeleton type can be improved.

In the timepiece of the present disclosure, the lower plate may include a logo display portion being position below the upper plate opening and displaying a logo.

The logo display portion is formed on the lower plate, and is provided to be visually recognized through the upper plate opening. Thus, the logo display unit is arranged at the depth position in the dial. The logo displayed in the logo display portion can be displayed sophisticatedly without being excessively noticeable, and the design can be improved.

The timepiece of the present disclosure may include a function part being attached to a front surface of the upper plate.

The function parts are attached to the front surface of the upper plate. Thus, a three-dimensional effect of the dial can further be emphasized, and the design can be improved.

In the timepiece of the present disclosure, the function part may include a power reserve indicator part for displaying an indicator of a power reserve hand, a sub-seconds hand indicator part for displaying an indicator of a sub-seconds hand, a decoration ring being provided at a position surrounding a periphery of the balance bush, and an hour mark.

Those function parts are attached to the front surface of the upper plate, and thus visibility of the indication positions of the small hands such as a power reserve hand and a sub-seconds hand can be improved. Further, the hour mark indicated by the hour hand and the minute hand is a function part, and hence the design of the dial can be improved. Moreover, the decoration ring that surrounds the periphery of the balance bush is provided as a function part. Thus, the cap jewel formed of a ruby is noticeable, and the design can be improved.

In the timepiece of the present disclosure, the bridge portion may include a first support bridge portion in which the first through hole is formed, a second support bridge portion in which the second through hole is formed, a third support bridge portion in which the third through hole is formed, and another bridge portion, and the first support bridge portion, the second support bridge portion, and the third support bridge portion may have width dimensions larger than that of the another bridge portion.

The width dimensions of the first to third support bridge portions are larger than those of the other bridge portions. Thus, the design in which the first and second hand shafts and the balance bush appear to be supported stably can be achieved.

In the timepiece of the present disclosure, the first hand and the second hand may be hands selected from a power reserve hand, a sub-seconds hand, a counting hand, a moon phase indicator hand, and a date indicator hand.

Each of the hands is selected from a power reserve hand, a sub-seconds hand, a counting hand, a moon phase indicator hand, and a date indicator hand, and thus information according to the function can be indicated with the hand.

In the timepiece of the present disclosure, at a center position of the dial in plan view, a hour hand shaft to which an hour hand is attached and a minute hand shaft to which a minute hand is attached may be coaxially arranged, the first hand shaft may be arranged in the 12 o'clock direction with respect to the hour hand shaft, the second hand shaft may be arranged in the 6 o'clock direction with respect to the hour hand shaft, the balance bush may be arranged in the 9 o'clock direction with respect to the hour hand shaft, the first hand may be the power reserve hand, and the second hand may be the sub-seconds hand. The hour hand and the minute hand are center hands that are positioned at the center position of the dial in plan view, and hence visibility at the time of pointing at an indicator can be improved. Further, the power reserve hand is arranged at the 12 o'clock position, the sub-seconds hand is arranged at the 6 o'clock position, and the balance bush is arranged at the 9 o'clock position. Thus, those components are arranged in a well-balanced manner, and the design of the timepiece can be improved.

In the timepiece of the present disclosure, the lower plate may include a logo display portion being positioned below the upper plate opening and displaying a logo, and the logo display portion may be arranged in the 3 o'clock direction with respect to the hour hand shaft.

On the dial, the power reserve hand is arranged at the 12 o'clock position, the sub-seconds hand is arranged at the 6 o'clock position, the balance bush is arranged at the 9 o'clock position, and the logo display portion is arranged at the 3 o'clock position. Thus, those components are arranged in a well-balanced manner, and the design of the timepiece can further be improved.

Second Overview

The timepiece of the present disclosure may include the dial and a sub dial mark attached to the upper surface of the dial. The sub dial mark may be formed into a ring-like shape that is partially cut off. The dial may include a support portion that is arranged on the back surface side of the sub dial mark and supports the sub dial mark. The support portion may be formed along the sub dial mark and may not be formed in the notch portion of the sub dial mark.

As a mechanical wrist watch including a mechanical movement, there has been known a timepiece configured so that timepiece components such as an escape wheel and pinion, a pallet fork, and a balance can visually be recognized from the dial side. For example, in JP-A-2020-148651, in a timepiece of a semi-skeleton type in which a window is formed in a part of a dial, a sub dial including a sub-seconds hand on the 6 o'clock position of the dial is provided. The sub dial is formed into a disk-like shape. As the timepiece is viewed from the dial side in plan view, the left half of the sub dial is mostly cut off. Thus, the escape wheel and pinion and the like are configured to be visually recognizable.

Meanwhile, in the timepiece of a full-skeleton type, the dial is configured as a frame. Thus, the area of the dial is reduced. Thus, when the sub dial is formed into a disk-like shape, the area of the dial for supporting the sub dial is excessively small. Thus, the sub dial is deformed due to an impact from a drop, which may lead to breakage.

In view of this, the sub dial is formed into a ring-like shape, and the dial of a full-skeleton type is provided with the support portion arranged below the sub dial mark. With this, the area of the support portion can be equivalent to that of the sub dial mark. Thus, even when an impact is applied, deformation of the sub dial mark can be suppressed, and breakage of the sub dial mark can be prevented.

Further, the sub dial mark is partially cut off, and the support portion is not formed in the notch portion of the sub dial mark. Thus, the timepiece components of the movement can visually be recognized easily through the notch portion of the sub dial mark.

Moreover, when the sub dial is configured as a ring-like shape, the dial of a full-skeleton type can be provided with a design that has an overall cohesive framework-like unity.

Note that, as in the exemplary embodiment described above, the dial is not limited to a laminated dial using the two plates including the lower plate and the upper plate, and may be a single-layer dial.

The timepiece of the present disclosure may include a movement including an escape wheel and pinion and a hand having a notch region overlapping with at least a part of the escape wheel and pinion in plan view during operation of the hand.

The cut-off region (notch region) is formed in the hand such as a center hand including a hand shaft at the center of the dial in plan view. With this, even when the hand overlaps with the escape wheel and pinion in plan view during operation, a part of the escape wheel and pinion is exposed through the notch region of the hand.

The hour hand and the minute hand have hand operation speeds lower than that of the seconds hand, and also have smaller movement angles per hour. Thus, a time period during which the hand overlaps with the escape wheel and pinion is longest in a case of the hour hand, and is shorter in the order of the minute hand and the seconds hand. Therefore, a time period during which the escape wheel and pinion can visually be recognized can be increased by forming the notch region in the hour hand or the minute hand. The seconds hand has a hand operation speed higher than those of the hour hand and the minute hand, and a time period during which the seconds hand overlaps with the escape wheel and pinion is shorter. Thus, the notch region is less required to be provided. Still, the notch region may be formed.

In the timepiece of the present disclosure, the sub dial mark may be formed into an arc shape, and may be cut off with the central angle falling within a range of 30 degrees or greater and 90 degrees or less. Moreover, the sub dial mark may be cut off with the central angle within a range of 60 degrees.

The sub dial mark displays a seconds indicator pointed by the sub-seconds hand. In a case in which the sub-seconds hand performs one rotation, that is, 360 degrees in 60 seconds, when the sub dial mark is cut off within a range of the central angle of 30 degrees, a time period during which the sub dial mark is capable of performing pointing is 55 seconds because the sub dial mark is provided within a range of 330 degrees. Similarly, when the sub dial mark is cut off within a range of the central angle of 90 degrees, a time period during which the sub dial mark is capable of performing pointing is 45 seconds because the sub dial mark is provided within a range of 270 degrees. Similarly, when the sub dial mark is cut off within a range of the central angle of 60 degrees, a time period during which the sub dial mark is capable of performing pointing is 50 seconds because the sub dial mark is provided within a range of 300 degrees.

Therefore, when the angle range of the notch portion of the sub dial mark is from 30 degrees to 90 degrees, a time period during which the sub dial mark cannot perform pointing is from 5 to 15 seconds. For the time period to this extent, even when the sub-seconds hand points at the notch portion of the sub dial mark, a user can intuitively have a rough understanding of the current seconds. Moreover, when the angle range of the notch portion of the sub dial mark is from 30 degrees to 90 degrees, the region of the escape wheel and pinion that can be visually recognized through the notch portion can be wider, and the escape wheel and pinion can be noticeable. Therefore, when the angle range of the notch portion of the sub dial mark is set to 30 degrees to 90 degrees, both improvement in visibility of the escape wheel and pinion and the time display function of the sub-seconds hand can be achieved.

Note that the sub dial mark is not limited to one for displaying the seconds indicator for the sub-seconds hand, and may be one for the hand for pointing at the indicator by rotating at 360 degrees.

In the timepiece of the present disclosure, the sub dial mark is formed to have a length in the circumferential direction within a predetermined angle range. The length dimension of the support portion in the circumferential direction may be 90% or more and 100% or less of the length dimension of the sub dial mark in the circumferential direction.

For example, when the sub dial mark is formed in the circumferential direction within the central angle range of 300 degrees, the length dimension of the support portion in the circumferential direction, which is arranged below the sub dial mark, is set within a range from 270 degrees to 300 degrees.

When the length of the support portion in the circumferential direction is secured to be 90% or more of the length of the sub dial mark, 90% or more of the sub dial mark can be supported and reinforced. Thus, deformation and breakage of the sub dial mark due to an impact can securely be prevented. Further, the length of the support portion in the circumferential direction is 100% or less of the length of the sub dial mark, and hence protrusion of the support portion from the edge of the sub dial mark can be prevented. As a result, degradation of visibility of the escape wheel and pinion and degradation of designability of the dial can be prevented.

In the timepiece of the present disclosure, the dial may include an outer circumferential ring portion that is formed along an outer circumference, a center ring portion that is arranged at the center position in plan view and is coupled to one end of the support portion, a bridge portion that couples the outer circumferential ring and the other end of the support portion, a coupling portion in which a through hole in which a hand shaft corresponding to the sub dial mark is arranged is formed, and a bridge portion that couples the outer circumferential ring portion and the coupling portion and is coupled to the support portion in an intersection arrangement.

Both the ends of the support portion of the dial to which the sub dial mark is attached are coupled to the center ring portion and the bridge portion. Further, the intermediate portion of the support portion is coupled to the bridge portion that is coupled to the coupling portion in which the through hole in which the hand shaft is arranged is formed. Thus, rigidity of the support portion can be improved, and attachment strength of the sub dial mark can be improved.

What is claimed is:

1. A timepiece comprising:
a movement including a plurality of timepiece components; and
a dial being provided above the movement, wherein
the movement includes:
a first hand shaft to which a first hand is attached;
a second hand shaft to which a second hand is attached; and
an escapement speed control mechanism including a balance and a balance bush configured to support the balance pivotally,
the dial includes a lower plate and an upper plate provided on the lower plate,
the lower plate includes:
a lower plate ring portion provided along an outer circumference; and
a frame portion coupled to an inner circumference of the lower plate ring portion,
the upper plate includes:
an upper plate ring portion provided along an outer circumference; and
a bridge portion coupled to an inner circumference of the upper plate ring portion,
a lower plate opening is formed in the lower plate, the lower plate opening being defined by the lower plate ring portion and the frame portion,
an upper plate opening is formed in the upper plate, the upper plate opening being defined by the upper plate ring portion and the bridge portion,
at least part of the frame portion is provided below the upper plate opening,
at least part of the lower plate opening is provided below the upper plate opening, and
the bridge portion includes:
a first through hole and a second through hole into which the first hand shaft and the second hand shaft are insertable, respectively; and
a third through hole formed at a position overlapping with the balance bush in plan view.

2. The timepiece according to claim 1, wherein
the lower plate includes a logo display portion being positioned below the upper plate opening and displaying a logo.

3. The timepiece according to claim 1, comprising
a function part being attached to a front surface of the upper plate.

4. The timepiece according to claim 3, wherein
the function part includes:
a power reserve indicator part for displaying an indicator of a power reserve hand;
a sub-seconds hand indicator part for displaying an indicator of a sub-seconds hand;
a decoration ring being provided at a position surrounding a periphery of the balance bush; and
an hour mark.

5. The timepiece according to claim 1, wherein
the bridge portion includes:
a first support bridge portion in which the first through hole is formed;
a second support bridge portion in which the second through hole is formed;
a third support bridge portion in which the third through hole is formed; and
another bridge portion, and
the first support bridge portion, the second support bridge portion, and the third support bridge portion have width dimensions larger than that of the other bridge portions.

6. The timepiece according to claim 1, wherein
the first hand and the second hand are hands selected from a power reserve hand, a sub-seconds hand, a counting hand, a moon phase indicator hand, and a date indicator hand.

7. The timepiece according to claim 6, wherein
at a center position of the dial in plan view, a hour hand shaft to which an hour hand is attached and a minute hand shaft to which a minute hand is attached are coaxially arranged,
the first hand shaft is arranged in a 12 o'clock direction with respect to the hour hand shaft,
the second hand shaft is arranged in a 6 o'clock direction with respect to the hour hand shaft, the balance bush is arranged in a 9 o'clock direction with respect to the hour hand shaft,
the first hand is the power reserve hand, and
the second hand is the sub-seconds hand.

8. The timepiece according to claim 7, wherein
the lower plate includes a logo display portion being positioned below the upper plate opening and displaying a logo, and
the logo display portion is arranged in a 3 o'clock direction with respect to the hour hand shaft.
